(19) United States
(12) Patent Application Publication
(10) Pub. No.: US 2026/0064511 A1
(43) Pub. Date: Mar. 5, 2026

(54) INTEGRATED CIRCUIT, WIRELESS COMMUNICATION DEVICE, AND ABNORMAL STATE ACQUISITION METHOD

(71) Applicant: Fujikura Ltd., Tokyo (JP)

(72) Inventor: Ken Sakuma, Sakura-shi (JP)

(73) Assignee: Fujikura Ltd., Tokyo (JP)

(21) Appl. No.: 19/312,893

(22) Filed: Aug. 28, 2025

(30) Foreign Application Priority Data
Sep. 2, 2024 (JP) 2024-150598

(51) Int. Cl. G06F 11/07

(52) U.S. Cl. CPC G06F 11/0769; G06F 11/0784

(57) ABSTRACT

A beamformer integrated circuit includes: an abnormality detection circuit configured to detect presence or absence of an abnormality; and a storage region including a detection result storage region configured to store a detection result of the abnormality detection circuit. In a case where a first communication message for instructing to specify an address to read out information stored in the storage region is received, a second communication message including information read out from a region of the storage region, which is specified by the address, and abnormal state presence/absence information indicating presence or absence of occurrence of an abnormality based on the detection result stored in the detection result storage region is transmitted.

### CROSS-REFERENCE TO RELATED APPLICATION

Priority is claimed on Japanese Patent Application No. 2024-150598, filed on Sep. 2, 2024, the content of which is incorporated herein by reference.

### BACKGROUND OF THE INVENTION

### Field of the Invention

The present invention relates to an integrated circuit, a wireless communication device, and an abnormal state acquisition method.

### Description of Related Art

Some integrated circuits are capable of detecting an abnormal state. For example, some radio frequency integrated circuits used in wireless communication devices include a power detector (PD) in a path from a power amplifier (PA) to an antenna, and can detect an abnormality in power of a wireless signal transmitted from the antenna according to a detection result of the power detector. Some of such integrated circuits store information indicating the detection result of the abnormal state.

The specification of the following U.S. Pat. No. 11,035,890 discloses an abnormality detection data recording device that can detect an abnormality and leave a history thereof. The abnormality detection data recording device includes a first semiconductor integrated circuit device and a second semiconductor integrated circuit device, transmits abnormality detection data indicating an abnormality detected by the first semiconductor integrated circuit device to the second semiconductor integrated circuit device, and stores the abnormality detection data in the second semiconductor integrated circuit device.

### SUMMARY OF THE INVENTION

By the way, in the technology disclosed in U.S. Pat. No. 11,035,890 described above, the abnormality detection data is stored in the second semiconductor integrated circuit device different from the first semiconductor integrated circuit device in which the abnormality is detected. Therefore, a dedicated wired communication circuit for transmitting the abnormality detection data is provided, and the abnormality detection data is transmitted to the second semiconductor integrated circuit device by the dedicated wired communication circuit each time the first semiconductor integrated circuit device detects an abnormality.

The present invention has been made in view of the above circumstances, and an object of the present invention is to provide an integrated circuit, a wireless communication device, and an abnormal state acquisition method capable of detecting occurrence of an abnormal state at an early stage without requiring a dedicated wired communication circuit.

In order to solve the above-described problem, an integrated circuit according to a first aspect of the present invention includes an abnormality detection circuit configured to detect presence or absence of an abnormality; and a storage region including a detection result storage region configured to store a detection result of the abnormality detection circuit. In a case where a first communication message for instructing to specify an address to read out information stored in the storage region is received, a second communication message including first information stored in a region of the storage region, which is specified by the address, and second information indicating presence or absence of occurrence of an abnormality based on the detection result stored in the detection result storage region is transmitted.

In the integrated circuit according to the first aspect of the present invention, the detection result of the abnormality detection circuit that detects the presence or absence of the abnormality is stored in the storage region, and in a case where the first communication message for instructing to specify the address to read out the information stored in the storage region is received, the second communication message including the first information stored in the region of the storage region, which is specified by the address, and the second information indicating the presence or absence of the occurrence of the abnormality based on the detection result stored in the detection result storage region is transmitted. Accordingly, it is possible to detect the occurrence of an abnormal state at an early stage without requiring a dedicated wired communication circuit.

An integrated circuit according to a second aspect of the present invention is the integrated circuit according to the first aspect of the present invention, in which the detection result storage region includes: a first storage region configured to store third information indicating a latest detection result of the abnormality detection circuit, and a second storage region provided to correspond to the first storage region and configured to store fourth information indicating a detection history of the abnormality detected by the abnormality detection circuit, and in a case where the fourth information is stored in the second storage region, the second communication message including the second information indicating the occurrence of the abnormality is transmitted.

An integrated circuit according to a third aspect of the present invention is the integrated circuit according to the second aspect of the present invention, in which, in a case where the first communication message for instructing to specify the address of the first storage region to read out the information stored in the first storage region is received, the second communication message including the third information stored in the first storage region as the first information is transmitted.

An integrated circuit according to a fourth aspect of the present invention is the integrated circuit according to any one of the first to third aspects of the present invention, in which the detection result storage region includes a third storage region configured to store fifth information indicating a state of the abnormality detected by the abnormality detection circuit as a plurality of histories, and in a case where the first communication message for instructing to specify an address of the third storage region to read out the information stored in the third storage region is received, the second communication message including the fifth information stored in a region of the third storage region, which is specified by the address as the first information is transmitted.

A wireless communication device according to a first aspect of the present invention includes the integrated circuit according to any one of the first to fourth aspects; and a control device configured to transmit the first communication message to the integrated circuit, in which the control device determines presence or absence of occurrence of an abnormality based on the second information included in the second communication message transmitted from the integrated circuit.

A wireless communication device according to a second aspect of the present invention is the wireless communication device according to the first aspect of the present invention, in which the control device transmits, in a case where the occurrence of the abnormality is determined, a third communication message for instructing to specify an address to read out the information stored in the detection result storage region to the integrated circuit.

An abnormal state acquisition method according to a first aspect of the present invention includes: a first step of transmitting the first communication message to the integrated circuit according to any one of the first to fourth aspects via a control device (50); and a second step of transmitting the second communication message to the control device in a case where the integrated circuit receives the first communication message.

An abnormal state acquisition method according to a second aspect of the present invention is the abnormal state acquisition method according to the first aspect of the present invention, further includes: a third step of determining presence or absence of occurrence of an abnormality based on the second information included in the second communication message transmitted from the integrated circuit, via the control device; and a fourth step of transmitting, in a case where the control device determines the occurrence of the abnormality, a third communication message for instructing to specify an address to read out the information stored in the detection result storage region, to the integrated circuit.

According to the present invention, there is an effect that the occurrence of an abnormal state can be detected at an early stage without requiring a dedicated wired communication circuit.

### BRIEF DESCRIPTION OF THE DRAWINGS

FIG. 1 is a system configuration diagram showing a configuration of a wireless communication device according to a first embodiment of the present invention.

FIG. 2 is a block diagram showing a main configuration of a beamformer integrated circuit according to the first embodiment of the present invention.

FIG. 3 is a diagram showing a connection relationship between a digital circuit unit and an analog circuit unit provided at an RF front end of the beamformer integrated circuit according to the first embodiment of the present invention.

FIG. 4 is a diagram showing a configuration example of an abnormality detection system that detects an output power abnormality by using a power detection signal output from a power detection circuit in the first embodiment of the present invention.

FIG. 5 is a diagram showing an example of a memory map of registers provided in the beamformer integrated circuit according to the first embodiment of the present invention.

FIG. 6A is a diagram showing an example of a read instruction communication message transmitted from a control device to the beamformer integrated circuit in the first embodiment of the present invention.

FIG. 6B is a diagram showing an example of a read reply communication message transmitted from the beamformer integrated circuit to the control device in the first embodiment of the present invention.

FIG. 6C is a diagram showing an example of a read reply communication message transmitted from the beamformer integrated circuit to the control device in the first embodiment of the present invention.

FIG. 7A is a diagram showing an example of a communication message in a case where information stored in a register to which an address K is assigned is read out in the first embodiment of the present invention.

FIG. 7B is a diagram showing an example of a communication message in a case where information stored in the register to which an address K is assigned is read out in the first embodiment of the present invention.

FIG. 8A is a diagram showing an example of a communication message in a case where information stored in a register to which an address K+1 is assigned is read out in the first embodiment of the present invention.

FIG. 8B is a diagram showing an example of a communication message in a case where information stored in the register to which the address K+1 is assigned is read out in the first embodiment of the present invention.

FIG. 9A is a diagram showing an example of a communication message in a case where information stored in a register to which an address L is assigned is read out in the first embodiment of the present invention.

FIG. 9B is a diagram showing an example of a communication message in a case where information stored in the register to which the address L is assigned is read out in the first embodiment of the present invention.

FIG. 10A is a diagram showing an example of a communication message in a case where information stored in a register to which an address L+1 is assigned is read out in the first embodiment of the present invention.

FIG. 10B is a diagram showing an example of a communication message in a case where information stored in the register to which the address L+1 is assigned is read out in the first embodiment of the present invention.

FIG. 11 is a diagram showing an example of a write instruction communication message transmitted from the control device to the beamformer integrated circuit.

FIG. 12 is a diagram showing an example of an operation instruction communication message transmitted from the control device to the beamformer integrated circuit.

FIG. 13 is a diagram showing an example of a memory map of registers provided in a beamformer integrated circuit according to a second embodiment of the present invention.

### DETAILED DESCRIPTION OF THE INVENTION

Hereinafter, an integrated circuit, a wireless communication device, and an abnormal state acquisition method according to embodiments of the present invention will be described in detail with reference to the drawings. In the following, a beamformer integrated circuit will be described as an example of the integrated circuit according to the embodiments of the present invention. In addition, a phased array antenna module and a wireless communication device including the beamformer integrated circuit will also be described.

### First Embodiment

### <Wireless Communication Device>

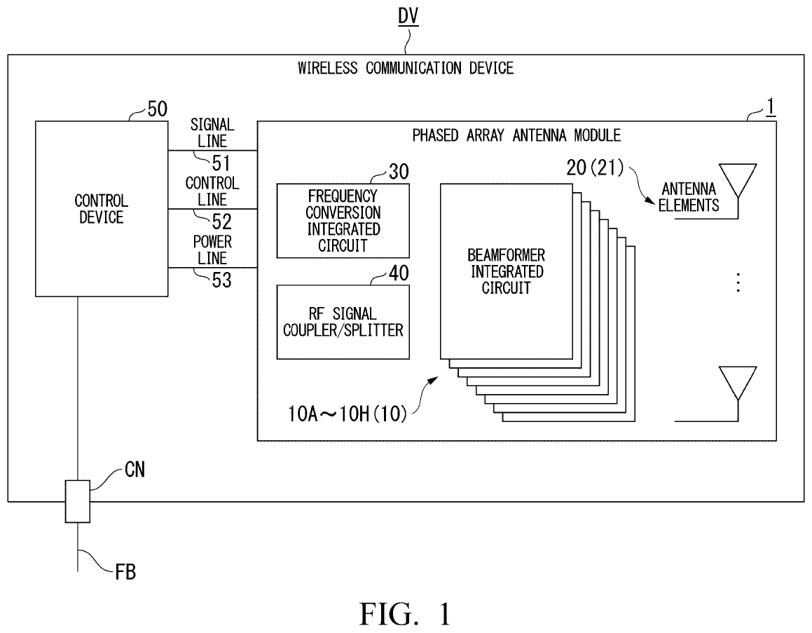

FIG. 1 is a system configuration diagram showing a configuration of a wireless communication device according to a first embodiment of the present invention. As shown in FIG. 1, the wireless communication device DV of the present embodiment includes a phased array antenna module 1 and a control device 50. The wireless communication device DV can perform beam forming that can freely change a beam pattern, for example, by using a millimeter wave band.

The phased array antenna module 1 has, for example, a plurality of integrated circuits (IC) mounted on one surface of a board such as a printed board in the related art, and an antenna array fabricated on the other surface. The plurality of integrated circuits and the antenna array that constitute the phased array antenna module 1 are formed by using a material in the related art and by using a method in the related art. In addition, an electrical connection structure between the plurality of integrated circuits and an electrical connection structure between an integrated circuit and the antenna array are not particularly limited. As the electrical connection structure, a connection structure in the related art is adopted.

The control device 50 communicates with, for example, an upper-level device (not shown) installed at a base portion of a pole or a tower, or in a telecommunications facility building, or the like via an optical fiber FB, and communicates with a facing wireless communication device such as a mobile terminal or a fixed wireless access network facility, a base station facility, or the like by using the phased array antenna module 1. The control device 50 includes an optical transceiver (not shown) or a pluggable type optical transceiver with an optical connector. The optical fiber FB is connected to an optical transceiver of the control device 50 via an optical connector CN installed in a housing of the wireless communication device DV.

### <Phased Array Antenna Module>

As shown in FIG. 1, the phased array antenna module 1 includes eight beamformer integrated circuits 10A, 10B, 10C, 10D, 10E, 10F, 10G, and 10H (hereinafter, referred to as beamformer integrated circuits 10A to 10H), an antenna array 20, a frequency conversion integrated circuit 30, and an RF signal coupler/splitter 40.

The phased array antenna module 1 is connected to the control device 50 via a signal line 51, a control line 52, and a power line 53. Transmission and reception of an RF signal having a signal frequency of an intermediate frequency (IF) are performed between the control device 50 and the phased array antenna module 1 via the signal line 51. Transmission and reception of a communication message related to the control are performed between the control device 50 and the phased array antenna module 1 via the control line 52. Power is supplied from the control device 50 to the phased array antenna module 1 via the power line 53.

The beamformer integrated circuits 10A to 10H are integrated circuits that control a beam pattern of the antenna array 20. A plurality of antenna elements 21 constituting the antenna array 20 are connected to each of the beamformer integrated circuits 10A to 10H. For example, eight antenna elements 21 for horizontal polarization and eight antenna elements 21 for vertical polarization are connected to each of the beamformer integrated circuits 10A to 10H. That is, the antenna array 20 is composed of a total of 128 antenna elements 21, which are 64 antenna elements 21 for horizontal polarization and 64 antenna elements 21 for vertical polarization. The details of the beamformer integrated circuits 10A to 10H will be described below.

The frequency conversion integrated circuit 30 is an integrated circuit that performs frequency conversion between an RF signal of an IF signal frequency and an RF signal of a frequency transmitted and received by the beamformer integrated circuits 10A to 10H and the antenna array 20.

The RF signal coupler/splitter 40 distributes the RF signal output from the frequency conversion integrated circuit 30 to each of the beamformer integrated circuits 10A to 10H. In addition, the RF signal coupler/splitter 40 couples the RF signals received by the respective beamformer integrated circuits 10A to 10H and inputs the coupled RF signals to the frequency conversion integrated circuit 30.

### <Beamformer Integrated Circuit>

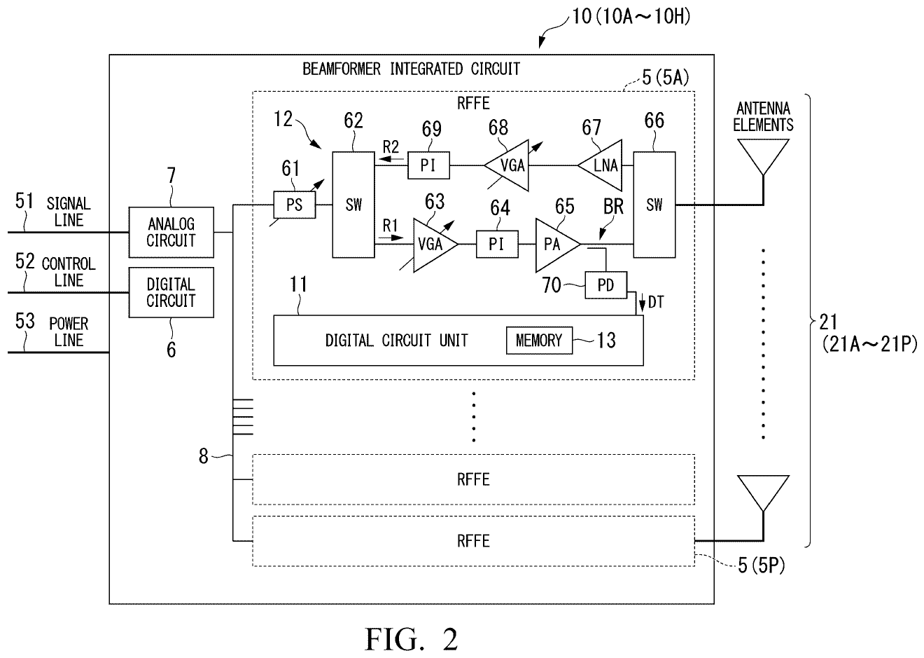

FIG. 2 is a block diagram showing a main configuration of a beamformer integrated circuit according to the first embodiment of the present invention. The eight beamformer integrated circuits 10A to 10H have the same configuration. Therefore, in the following description, one of the beamformer integrated circuits 10A to 10H, that is, a beamformer integrated circuit 10 may be described. The description of the other seven beamformer integrated circuits may be omitted.

The beamformer integrated circuit 10 (integrated circuit) includes 16 RF front ends (RFFE) 5A to 5P, a digital circuit 6, an analog circuit 7, and an RF signal coupler/splitter 8. The 16 RF front ends 5A to 5P have the same configuration as each other. Therefore, in the following description, there is a case where one of the 16 RF front ends 5A to 5P, that is, an RF front end 5 will be described. The description of the other 15 RF front ends may be omitted.

In the one beamformer integrated circuit 10 shown in FIG. 2, each of the 16 RF front ends 5A to 5P is connected to each of 16 antenna elements 21A to 21P such that the one antenna element 21 corresponds to the one RF front end 5 on a one-to-one basis. Among the 16 RF front ends 5A to 5P and the 16 antenna elements 21A to 21P, eight RF front ends (for example, RF front ends 5A to 5H) and eight antenna elements (for example, antenna elements 21A to 21H) are for horizontal polarization, and the remaining eight RF front ends (for example, RF front ends 5I to 5P) and eight antenna elements (for example, antenna elements 21I to 21P) are for vertical polarization.

The 16 antenna elements 21A to 21P have the same configuration or similar configuration to each other. Therefore, in the following description, one of the 16 antenna elements 21A to 21P, that is, the antenna element 21 may be described. The description of the other 15 antenna elements may be omitted. The antenna elements 21A to 21P may have the same configuration as each other. Regarding the configuration of each of the antenna elements 21A to 21P, the configuration of the antenna elements for horizontal polarization may be slightly different from the configuration of the antenna elements for vertical polarization.

In this way, in the one beamformer integrated circuit 10, each of the 16 RF front ends 5A to 5P is connected to each of the 16 antenna elements 21A to 21P on a one-to-one basis. Therefore, in the entire phased array antenna module 1 having the eight beamformer integrated circuits 10A to 10H, each of the 128 antenna elements 21 constituting the antenna array 20 is connected to each of the 16 RF front ends 5A to 5P in each of the eight beamformer integrated circuits 10A to 10H.

The 128 antenna elements 21 constituting the antenna array 20 are divided into the 64 antenna elements 21 that transmit and receive radio waves of horizontal polarization and the 64 antenna elements 21 that transmit and receive radio waves of vertical polarization. The eight beamformer integrated circuits 10A to 10H control transmission and reception of the radio waves of horizontal polarization in the 64 antenna elements 21, and control transmission and reception of the radio waves of vertical polarization in the 64 antenna elements 21. Regarding each of the radio waves of horizontal polarization and the radio waves of vertical polarization, the beamformer integrated circuits 10A to 10H set the phases and intensities of each of the 64 antenna elements 21 such that the direction of the combined radio wave transmitted or received from the 64 antenna elements 21 is a predetermined direction.

As shown in FIG. 2, the RF front end 5 includes a digital circuit unit 11 and an analog circuit unit 12 (circuit unit). The digital circuit unit 11 transmits and receives a communication message related to the control to and from the control device 50 via the control line 52 shown in FIG. 1. The digital circuit unit 11 controls the RF front end 5 based on the communication message transmitted from the control device 50.

In the present embodiment, the transmission and reception of a communication message related to the control are performed via the parallel communication between the phased array antenna module 1 and the control device 50. That is, the digital circuit unit 11 transmits and receives the communication message related to the control by the parallel communication to and from the control device 50. The communication performed between the phased array antenna module 1 and the control device 50 is not limited to the parallel communication. The communication may be serial communication such as serial peripheral interface (SPI) or inter-integrated circuit (I2C).

The digital circuit unit 11 is connected to the digital circuit 6 by a wiring line inside the beamformer integrated circuit 10. The digital circuit 6 relays the communication performed between the digital circuit unit 11 and the control device 50. Alternatively, the digital circuit 6 communicates with the digital circuit unit 11 based on the content of the communication message transmitted from the control device 50.

One communication transaction transmitted from the control device 50 to the phased array antenna module 1 includes additional information, a command, and data. The communication transaction has a fixed bit length. The command is a register address when instructing to write into or read out from the register. Alternatively, the command is a numerical value meaning an operation instruction to the beamformer integrated circuit 10 or the RF front end 5. The command or data has a fixed length. In the present embodiment, the command is 8 bits and the data is 16 bits.

The digital circuit unit 11 includes a memory 13 that is a storage region for storing a beam table used for beam forming. The beam table is a look-up table that stores a plurality of combinations of phase shift amount setting values and intensity setting values that are set according to the beam pattern of the antenna array 20 to be controlled. In the present embodiment, a beam table (beam table of 2048 items) in which 2048 combinations of the phase shift amount setting values and the intensity setting values are defined is stored in the memory 13.

The memory 13 is realized by using, for example, a static random access memory (SRAM). The memory 13 is preferably realized using the SRAM, but may be realized using a register or may be realized using a dynamic random access memory (DRAM), a flash memory, or a read only memory (ROM).

The analog circuit unit 12 is a circuit that outputs an RF signal to the antenna element 21 connected to the RF front end 5 or receives an RF signal output from the antenna element 21. The analog circuit unit 12 adjusts the phase and the intensity of the RF signal transmitted and received by the antenna element 21 connected to the RF front end 5 under the control of the digital circuit unit 11.

The analog circuit unit 12 is connected to the analog circuit 7 via the RF signal coupler/splitter 8. The RF signal coupler/splitter 8 distributes the RF signal output from the analog circuit 7 to the analog circuit unit 12 provided in each of the RF front ends 5A to 5P. In addition, the RF signal coupler/splitter 8 couples the RF signals output from the analog circuit unit 12 provided in each of the RF front ends 5A to 5P and outputs the coupled RF signal to the analog circuit 7.

As shown in FIG. 2, the analog circuit unit 12 includes a phase shifter (PS) 61, a path selection switch (SW) 62, a variable gain amplifier (VGA) 63, a phase inverter (PI) 64, a power amplifier (PA) 65, a path selection switch (SW) 66, a low-noise amplifier (LNA) 67, a variable gain amplifier (VGA) 68, a phase inverter (PI) 69, and a power detection circuit (PD) 70.

The variable gain amplifier 63, the phase inverter 64, and the power amplifier 65 are provided on a transmission path R1, and the low-noise amplifier 67, the variable gain amplifier 68, and the phase inverter 69 are provided on a reception path R2. The transmission path R1 is a path through which the RF signal (high-frequency signal) output to the antenna element 21 passes, and the reception path R2 is a path through which the RF signal (high-frequency signal) input from the antenna element 21 passes. The path selection switches 62 and 66 switch between whether the transmission path R1 is connected and whether the reception path R2 is connected between the phase shifter 61 and the antenna element 21 at a defined time interval. Accordingly, the phased array antenna module 1 can transmit and receive a high-frequency signal as a time division multiplexing system.

The phase shifter 61 adjusts the phase shift amount of the RF signal passing through the transmission path R1 or the RF signal passing through the reception path R2 according to the phase shift amount setting value of the beam table read out from the memory 13 of the digital circuit unit 11. That is, the phase shifter 61 is provided in common to the transmission path R1 and the reception path R2. A configuration may be adopted in which the phase shifter 61 common to the transmission path R1 and the reception path R2 is omitted and a phase shifter is individually provided in each of the transmission path R1 and the reception path R2.

The variable gain amplifier 63 amplifies the RF signal passing through the transmission path R1 according to the intensity setting value of the beam table read out from the memory 13. The phase inverter 64 inverts the phase of the RF signal passing through the transmission path R1 according to the phase shift amount setting value of the beam table read out from the memory 13. The power amplifier 65(power amplifier) amplifies the RF signal passing through the transmission path R1 at a predetermined amplification factor. By adjusting the phase shift amount and the intensity of the RF signal passing through the transmission path R1, the beam pattern of the radio wave transmitted from the phased array antenna module 1 can be changed.

The low-noise amplifier 67 amplifies the RF signal output from the path selection switch 66 at a predetermined amplification factor. The variable gain amplifier 68 amplifies the RF signal passing through the reception path R2 according to the intensity setting value of the beam table read out from the memory 13. The phase inverter 69 inverts the phase of the RF signal passing through the reception path R2 according to the phase shift amount setting value of the beam table read out from the memory 13. By adjusting the phase shift amount and the intensity of the RF signal passing through the reception path R2, the beam pattern of the radio wave received by the phased array antenna module 1 can be changed.

The power detection circuit 70 detects the power of the RF signal amplified by the power amplifier 65 and supplied to the antenna element 21, and outputs a power detection signal DT (digital signal) indicating the detection result. Specifically, the power detection circuit 70 detects the power of one RF signal branched by a branching device BR provided in the transmission path R1, and outputs the power detection signal DT indicating the detection result. The power detection signal DT is a signal having a “high” (H) level or a “low” (L) level according to the magnitude of the power of the detected RF signal. The power detection signal DT is input to the digital circuit unit 11 in the RF front end 5.

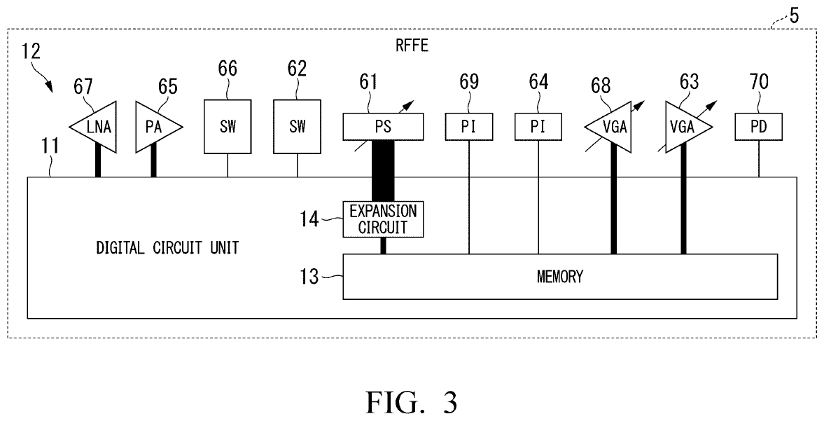

FIG. 3 is a diagram showing a connection relationship between a digital circuit unit and an analog circuit unit provided at an RF front end of the beamformer integrated circuit according to the first embodiment of the present invention. As shown in FIG. 3, the phase shifter 61, the variable gain amplifiers 63 and 68, and the phase inverters 64 and 69 provided in the analog circuit unit 12 are controlled in accordance with the contents of the beam table stored in the memory 13. In contrast, the path selection switches 62 and 66, the power amplifier 65, and the low-noise amplifier 67 provided in the analog circuit unit 12 are controlled by a logic circuit (not shown) such as a register provided in the digital circuit unit 11. The power detection signal DT output from the power detection circuit 70 is input to the digital circuit unit 11.

An expansion circuit 14 expands a bit string of a phase shift amount setting value of the beam table read out from the memory 13 into a bit string of a control value (phase shifter control value) for controlling the phase shifter 61. The phase shift amount setting value stored in the beam table is, for example, 7 bits, and the intensity setting value is, for example, 5 bits. The expansion circuit 14 expands a bit string of 6 bits of the phase shift amount setting value of 7 bits into a bit string of 52 bits of the control value. The remaining one bit of the phase shift amount setting value is used for controlling the phase inverters 64 and 69. The number of bits of the phase shift amount setting value is set according to the resolution of the phase shift amount, and the number of bits of the control value is set according to the number of divided units constituting the phase shifter 61.

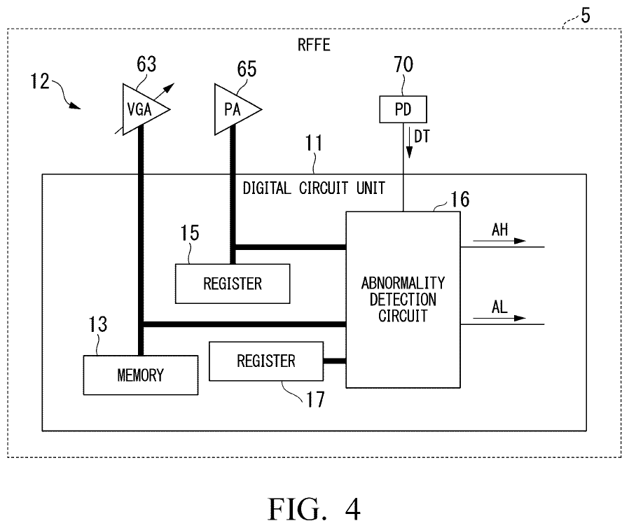

FIG. 4 is a diagram showing a configuration example of an abnormality detection system that detects an output power abnormality by using a power detection signal output from a power detection circuit in the first embodiment of the present invention. The abnormality detection system shown in FIG. 4 includes the memory 13, a register 15, a register 17, and an abnormality detection circuit 16 (abnormality detection circuit) provided in the digital circuit unit 11.

As described above, the memory 13 stores a beam table including gain setting values that define the gain of the variable gain amplifier 63. The register 15 holds a gain setting value that defines the gain of the power amplifier 65. The gain setting value held in the register 15 can be rewritten based on an instruction from the control device 50. That is, in the abnormality detection system shown in FIG. 4, the gain of the power amplifier 65 can be appropriately changed, and the gain of the RF signal passing through the transmission path R1 of the analog circuit unit 12 is defined by the gain setting value read out from the memory 13 and the gain setting value held in the register 15. Hereinafter, the gain setting value that defines the gain of the RF signal passing through the transmission path R1 of the analog circuit unit 12 is referred to as a “transmission signal gain setting value”.

The register 17 stores a high output setting reference value RH and a low output setting reference value RL used in a case where the presence or absence of an abnormality in the output power of the power amplifier 65 is detected. The high output setting reference value RH and the low output setting reference value RL are reference values set with respect to the transmission signal gain setting value. The high output setting reference value RH and the low output setting reference value RL held in the register 17 can be rewritten based on an instruction from the control device 50.

Specifically, the high output setting reference value RH is a reference value for determining whether or not the transmission signal gain setting value causes the output power of the power amplifier 65 to be larger than a predetermined first power (to be a high output). The low output setting reference value RL is a reference value for determining whether or not the transmission signal gain setting value causes the output power of the power amplifier 65 to be a predetermined second power lower than the first power (to be a low output).

The high output setting reference value RH and the low output setting reference value RL are set such that the high output setting reference value RH is larger than the low output setting reference value RL in a range in which the output power of the power amplifier 65 can be changed. In this case, the power detection signal DT is set such that the level is switched in a case where the gain setting value is between the high output setting reference value RH and the low output setting reference value RL.

The abnormality detection circuit 16 detects the presence or absence of an abnormality in the RF signal (output power of the power amplifier 65) amplified by the power amplifier 65 and supplied to the antenna element 21 based on the transmission signal gain setting value and the power detection signal DT output from the power detection circuit 70. The abnormality detection circuit 16 uses the high output setting reference value RH and the low output setting reference value RL stored in the register 17 in a case where the presence or absence of the abnormality of the output power of the power amplifier 65 is detected.

In a case where the transmission signal gain setting value is larger than the high output setting reference value RH and the power detection signal DT is at an “L” level, the abnormality detection circuit 16 outputs a low output abnormality detection signal AL. That is, in a case where the power detected by the power detection circuit 70 is low even though the transmission signal gain setting value is a value instructing high output, the abnormality detection circuit 16 detects an abnormality and outputs the low output abnormality detection signal AL at a “H”level.

In a case where the transmission signal gain setting value is smaller than the low output setting reference value RL and the power detection signal DT is at the “H” level, the abnormality detection circuit 16 outputs a high output abnormality detection signal AH. That is, in a case where the power detected by the power detection circuit 70 is high even though the transmission signal amplification factor setting value is a value instructing low output, the abnormality detection circuit 16 detects an abnormality and outputs the high output abnormality detection signal AH at the “H”level.

In a case where the transmission signal gain setting value is smaller than the high output setting reference value RH and larger than the low output setting reference value RL, the abnormality detection circuit 16 does not output the low output abnormality detection signal AL and the high output abnormality detection signal AH regardless of the level of the power detection signal DT. That is, the abnormality detection circuit 16 does not detect the abnormality of the output power because the transmission signal amplification factor setting value is a value between the value instructing high output and the value instructing low output. That is, the low output abnormality detection signal AL and the high output abnormality detection signal AH are at the “L”level.

The detection results (high output abnormality detection signal AH and low output abnormality detection signal AL) of the abnormality detection circuit 16 are stored in a register (not shown) provided in the digital circuit unit 11. The control device 50 transmits a communication message for performing an acquisition request to the digital circuit unit 11 to acquire the detection results of the abnormality detection circuit 16 stored in the register.

In addition, the beamformer integrated circuit 10 is provided with an abnormality detection system that detects a protocol abnormality in addition to the abnormality detection system that detects the output power abnormality shown in FIG. 4. The abnormality detection system includes, for example, a protocol abnormality detection circuit (abnormality detection circuit) (not shown) provided in the digital circuit 6 and the digital circuit unit 11 of the RF front end 5. The protocol abnormality detection circuit detects a communication protocol error (communication message protocol abnormality) between the control device 50 and the digital circuit 6 and between the control device 50 and the digital circuit unit 11 of the RF front end 5.

A detection result of the protocol abnormality detection circuit provided in the digital circuit 6 is stored in a register (not shown) provided in the digital circuit 6. A detection result of the protocol abnormality detection circuit provided in the digital circuit unit 11 of the RF front end 5 is stored in a register (not shown) provided in the digital circuit unit 11 of the RF front end 5. The control device 50 transmits a communication message for performing an acquisition request to the digital circuit 6 or the digital circuit unit 11 of the RF front end 5 to acquire the detection result of the protocol abnormality detection circuit stored in each register.

### <Memory Map of Register>

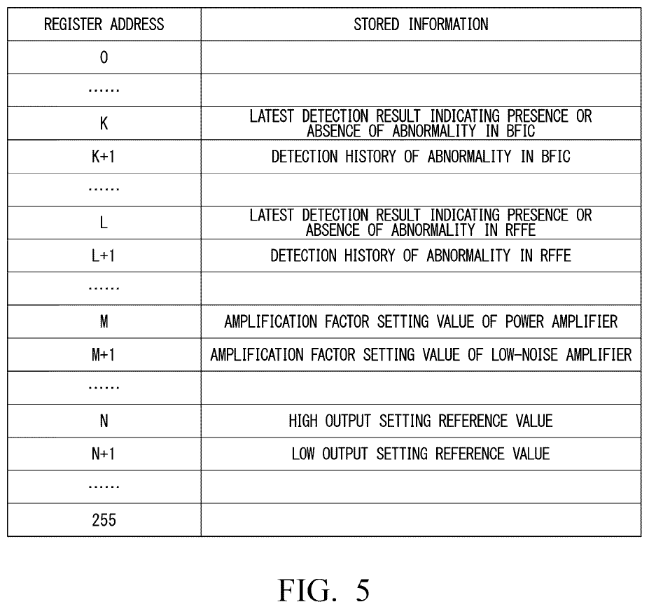

FIG. 5 is a diagram showing an example of a memory map of registers provided in the beamformer integrated circuit according to the first embodiment of the present invention. In the present embodiment, the addresses of the memory map of the registers are 8 bits, and values from “0” to “255” can be specified. In addition, the storage capacity of each register is, for example, a maximum of 16 bits. In the present embodiment, an 8-bit address space is shared by registers (storage region) provided in the frequency conversion integrated circuit 30, registers (storage region) provided in the digital circuit 6 of the beamformer integrated circuit 10, and registers (storage region) provided in the digital circuit unit 11 of the RF front end 5.

The registers are storage regions in which information is stored by specifying an address to perform a write operation, and the stored information can be acquired by specifying an address to perform a read operation. In addition, the information may be stored in the registers or the information stored in the registers may be updated by the digital circuit 6 of the beamformer integrated circuit 10 or the logic circuit provided in the digital circuit unit 11 of the RF front end 5.

In the example shown in FIG. 5, registers to which an address K and an address K+1 are assigned are the registers provided in the digital circuit 6 of the beamformer integrated circuit 10. In addition, registers to which an address L, an address L+1, an address M, an address M+1, an address N, and an address N+1 are assigned are the registers provided in the digital circuit unit 11 of the RF front end 5.

That is, in a case where the write operation or the read operation is instructed by specifying the address K or the address K+1, writing or reading is performed with respect to a register provided in the digital circuit 6 of the beamformer integrated circuit 10. In addition, in a case where the write operation or the read operation is instructed by specifying the address L, the address L+1, the address M, the address M+1, the address N, and the address N+1, writing or reading is performed with respect to the registers provided in the digital circuit unit 11 of the RF front end 5 separately selected in advance. The selection and specification of the RF front end 5 is performed, for example, by using a register (not shown) provided in the digital circuit 6 of the beamformer integrated circuit 10.

Although not shown in FIG. 5, a certain address range is also assigned to the registers provided in the frequency conversion integrated circuit 30. In a case where the write operation or the read operation is instructed by specifying an address within this range, writing or reading is performed with respect to a register provided in the frequency conversion integrated circuit 30.

Information (third information) indicating the latest detection result indicating the presence or absence of detection of an abnormality in the abnormality detection circuit provided in the digital circuit 6 of the beamformer integrated circuit 10 is stored in a register (detection result storage region, first storage region) to which the address K is assigned. In addition, information (fourth information) indicating a detection history of the abnormality detected by the abnormality detection circuit provided in the digital circuit 6 of the beamformer integrated circuit 10 is stored in a register (detection result storage region, second storage region) to which the address K+1 is assigned.

Information (third information) indicating the latest detection result indicating the presence or absence of detection of an abnormality in the abnormality detection circuit provided in the digital circuit unit 11 of the RF front end 5 is stored in a register (detection result storage region, first storage region) to which the address L is assigned. In addition, information (fourth information) indicating a detection history of the abnormality detected by the abnormality detection circuit provided in the digital circuit unit 11 of the RF front end 5 is stored in a register (detection result storage region, second storage region) to which the address L+1 is assigned.

The gain setting value that defines the gain of the power amplifier 65 provided in the RF front end 5 is stored in a register to which the address M is assigned. A gain setting value that defines the gain of the low-noise amplifier 67 provided in the RF front end 5 is stored in a register to which the address M+1 is assigned. The high output setting reference value RH is stored in a register to which the address N is assigned. The low output setting reference value RL is stored in a register to which the address N+1 is assigned. The register to which the address M is assigned is the register 15 shown in FIG. 4, and the register to which the address N and the address N+1 are assigned is the register 17 shown in FIG. 4.

The information stored in the register to which the address K is assigned and the register to which the address K+1 is assigned is composed of a plurality of bits. For example, the information is composed of a bit (hereinafter, referred to as an “RFFE abnormality detection bit”) indicating whether or not an abnormality is detected in the RF front end 5, a bit (hereinafter, referred to as a “first communication error detection bit”) indicating whether or not a communication protocol error is detected in the digital circuit 6, and the like. The information stored in the register to which the address K is assigned and the register to which the address K+1 is assigned is updated in units of bits according to the abnormality detected by the beamformer integrated circuit 10.

The information stored in the register to which the address L is assigned and the register to which the address L+1 is assigned also is composed of a plurality of bits. For example, the information is composed of a bit indicating whether or not an abnormality is detected in the RF front end 5, a bit (hereinafter, referred to as a “high output abnormality detection bit”) indicating whether or not a high output abnormality is detected, a bit (hereinafter, referred to as a “low output abnormality detection bit”) indicating whether or not a low output abnormality is detected, a bit (hereinafter, referred to as a “second communication error detection bit”) indicating whether or not a communication protocol error is detected in the digital circuit unit 11 of the RF front end 5, and the like. The information stored in the register to which the address L is assigned and the register to which the address L+1 is assigned is updated in units of bits according to the abnormality detected by the RF front end 5.

In a case where a communication message (hereinafter, referred to as a “read instruction communication message (i.e., read request communication message)”) (first communication message) is received, which is a communication message for instructing to specify an address to read out the information stored in a register to which the address is assigned, the beamformer integrated circuit 10 reads out the information (first information) stored in the register to which the address is assigned. For example, in a case where a read instruction communication message in which the address K is specified is received, the beamformer integrated circuit 10 reads out the information stored in the register to which the address K is assigned.

In addition, the beamformer integrated circuit 10 sets a value of information (hereinafter, referred to as “abnormal state presence/absence information”) (second information) indicating the presence or absence of the occurrence of an abnormality based on the information stored in the register to which the address K+1 is assigned. For example, in a case where the value of the information stored in the register to which the address K+1 is assigned is not “0”, the beamformer integrated circuit 10 sets the value of the abnormal state presence/absence information to “1”. That is, in a case where the information (fourth information) indicating the detection history of the abnormality is stored in the register to which the address K+1 is assigned, the beamformer integrated circuit 10 sets the value of the abnormal state presence/absence information to “1”. In a case where the value of the information stored in the register to which the address K+1 is assigned is “0”, the beamformer integrated circuit 10 sets the value of the abnormal state presence/absence information to “0”.

Alternatively, the beamformer integrated circuit 10 sets the value of the abnormal state presence/absence information (second information) based on the information stored in the register to which the address K+1 is assigned and the register to which the address L+1 is assigned. For example, in a case where the value of the information stored in the register to which the address K+1 is assigned is not “0”, the beamformer integrated circuit 10 sets the value of the abnormal state presence/absence information (hereinafter, referred to as “BFIC abnormal state presence/absence information”) in the beamformer integrated circuit 10 to “1”. In addition, in a case where the value of the information stored in the register to which the address L+1 is assigned is not “0”, the beamformer integrated circuit 10 sets the value of the abnormal state presence/absence information (hereinafter, referred to as “RFFE abnormal state presence/absence information”) in the RF front end 5 to “1”.

That is, in a case where the information (fourth information) indicating the detection history of the abnormality is stored in the register to which the address K+1 is assigned, the beamformer integrated circuit 10 sets the value of the BFIC abnormal state presence/absence information to “1”. In addition, in a case where the information (fourth information) indicating the detection history of the abnormality is stored in the register to which the address L+1 is assigned, the beamformer integrated circuit 10 sets the value of the RFFE abnormal state presence/absence information to “1”.

In a case where the value of the information stored in the register to which the address K+1 is assigned is “0”, the beamformer integrated circuit 10 sets the value of the BFIC abnormal state presence/absence information to “0”. In addition, in a case where the value of the information stored in the register to which the address L+1 is assigned is “0”, the beamformer integrated circuit 10 sets the value of the RFFE abnormal state presence/absence information to “0”.

Then, the beamformer integrated circuit 10 transmits a communication message (hereinafter, referred to as a “read reply communication message (i.e., read response communication message)”) (second communication message) including the read information (first information) and the abnormal state presence/absence information (second information). For example, in a case where a read instruction communication message (first communication message) is transmitted from the control device 50, a read reply communication message (second communication message) including the read information (first information) and the abnormal state presence/absence information (second information) is transmitted to the control device 50.

### <Operation When Abnormality is Detected>

Next, an operation in a case where the presence or absence of an abnormality is detected in the abnormality detection circuit provided in the digital circuit 6 of the beamformer integrated circuit 10 or the abnormality detection circuit provided in the digital circuit unit 11 of the RF front end 5 will be described. In the following, first, in the abnormality detection circuit provided in the digital circuit unit 11 of the RF front end 5, an operation (operation when an output abnormality is detected) in a case where the presence or absence of the output abnormality of the power amplifier 65 is detected will be described. Next, an operation (operation when a communication error is detected) in a case where the presence or absence of the communication protocol error is detected in the abnormality detection circuit provided in the digital circuit 6 or the abnormality detection circuit provided in the digital circuit unit 11 of the RF front end 5 will be described. Subsequently, an operation (reset operation) in a case where the stored content of a register is cleared will be described.

### <<Operation When Output Abnormality is Detected>>

In the abnormality detection system shown in FIG. 4, in a case where a high output abnormality of the output power of the power amplifier 65 is detected, the high output abnormality detection signal AH is output from the abnormality detection circuit 16 of the abnormality detection system. Then, for example, the value of the high output abnormality detection bit is set to, for example, “1” in the register to which the address L is assigned, by the logic circuit provided in the digital circuit unit 11 of the RF front end 5. In addition, in the register to which the address L+1 is assigned, the value of the high output abnormality detection bit is also set to, for example, “1”.

In a case where a high output abnormality is not detected, only the value of a high output abnormality detection bit in the register to which the address L is assigned is set to, for example, “0”. The value is held for the high output abnormality detection bit in the register to which the address L+1 is assigned. That is, the step of setting the value of the high output abnormality detection bit to “0” is not performed in the register to which the address L+1 is assigned.

In the abnormality detection system shown in FIG. 4, in a case where a low output abnormality of the output power of the power amplifier 65 is detected, the low output abnormality detection signal AL is output from the abnormality detection circuit 16 of the abnormality detection system. Then, for example, the value of the low output abnormality detection bit is set to, for example, “1” in the register to which the address L is assigned, by the logic circuit provided in the digital circuit unit 11 of the RF front end 5 (first step). In addition, in the register to which the address L+1 is assigned, similarly, the value of the low output abnormality detection bit is set to, for example, “1”.

In a case where a low output abnormality is not detected, only the value of the low output abnormality detection bit in the register to which the address L is assigned is set to, for example, “0”. The value is held for the low output abnormality detection bit in the register to which the address L+1 is assigned. That is, the step of setting the value of the low output abnormality detection bit to “0” is not performed in the register to which the address L+1 is assigned.

### <<Operation When Communication Error is Detected>>

It is assumed that a communication protocol error is detected by the protocol abnormality detection circuit (not shown) provided in the digital circuit 6. Then, for example, the value of the first communication error detection bit is set to, for example, “1” in the register to which the address K is assigned, by the logic circuit provided in the digital circuit 6. In addition, in the register to which the address K+1 is assigned, the value of the first communication error detection bit is also set to, for example, “1”.

In a case where a communication protocol error is not detected by the protocol abnormality detection circuit (not shown) provided in the digital circuit 6, only the value of the first communication error detection bit in the register to which the address K is assigned is set to, for example, “0”. The value is held for the first communication error detection bit in the register to which the address K+1 is assigned. That is, the step of setting the value of the first communication error detection bit to “0” is not performed in the register to which the address K+1 is assigned.

It is assumed that a communication protocol error is detected by the protocol abnormality detection circuit (not shown) provided in the digital circuit unit 11 of the RF front end 5. Then, for example, the value of the second communication error detection bit is set to, for example, “1” in the register to which the address L is assigned, by the logic circuit provided in the digital circuit unit 11 of the RF front end 5. In addition, in the register to which the address L+1 is assigned, the value of the second communication error detection bit is also set to, for example, “1”.

In a case where a communication protocol error is not detected by the protocol abnormality detection circuit (not shown) provided in the digital circuit unit 11 of the RF front end 5, only the value of the second communication error detection bit in the register to which the address L is assigned is set to, for example, “0”. The value is held for the second communication error detection bit in the register to which the address L+1 is assigned. That is, the step of setting the value of the second communication error detection bit to “0” is not performed in the register to which the address L+1 is assigned.

Here, in a case where the value of any bit in the register to which the address L is assigned is “1”, the value of the RFFE abnormality detection bit is set to, for example, “1” in the register to which the address K is assigned and the register to which the address K+1 is assigned. The case where the value of any bit in the register to which the address L is assigned is “1” is a case where the value of the information stored in the register to which the address L is assigned is not “0”.

In contrast, in a case where the values of all bits in the register to which the address L is assigned are “0”, only the value of the RFFE abnormality detection bit in the register to which the address K is assigned is set to, for example, “0”. The value is held for the RFFE abnormality detection bit in the register to which the address K+1 is assigned. The case where the values of all bits in the register to which the address L is assigned are “0” is a case where the value of the information stored in the register to which the address L is assigned is “0”.

In this way, in the register to which the address K+1 is assigned, the information indicating the detection history of the abnormality detected by the beamformer integrated circuit 10 is stored by using a plurality of bits, and in a case where there is the detection history, the value of the corresponding bit is, for example, “1”. In a case where an abnormality is detected by the abnormality detection circuit provided in the digital circuit unit 11 of any RF front end 5, the values of specific bits of both the register to which the address L+1 is assigned and the register to which the address K+1 is assigned are “1”. Accordingly, it is possible to determine the presence or absence of the detection history of the abnormality detected by the beamformer integrated circuit 10 by referring only to the register to which the address K+1 is assigned.

### <<Reset Operation>>

The value stored in the register to which the address K+1 is assigned is set to “0” (reset) during the initialization operation of the register or in a case where the digital circuit 6 of the beamformer integrated circuit 10 receives a communication message for instructing to specify the address K+1 to clear the contents. Similarly, the value stored in the register to which the address L+1 is assigned is set to “0” (reset) during the initialization operation of the register or in a case where the digital circuit 6 of the beamformer integrated circuit 10 receives a communication message for instructing to specify the address L+1 to clear the contents.

Setting the value stored in the register to which the address K+1 is assigned and the value stored in the register to which the address L+1 is assigned to “0” means that a state where there is no detection history of the abnormality detected in the past is set. In this way, the state where there is no detection history of the abnormality detected in the past is set during the initialization operation of the register or when a communication message indicating the clearing of the history is received. Therefore, for example, in a case where the wireless communication device DV is continuously operated, the acquisition of the detection history of the abnormality and the clearing of the acquired detection history can be appropriately repeated.

### <Abnormal State Acquisition Method>

Next, an abnormal state acquisition method according to the first embodiment of the present invention will be described. In the abnormal state acquisition method according to the present embodiment, for example, the following first step to fifth step are repeatedly performed at a predetermined cycle or irregularly.

First step: transmission of read instruction communication message

The control device 50 transmits a read instruction communication message (first communication message) to the beamformer integrated circuit 10 for instructing to specify an address to read out information stored in a register to which the address is assigned.

Second step: transmission of read reply communication message

In a case where the beamformer integrated circuit 10 receives the read instruction communication message transmitted from the control device 50, the beamformer integrated circuit 10 transmits a read reply communication message (second communication message) including information (first information) stored in a region specified by the address included in the read instruction communication message and the abnormal state presence/absence information (second information) to the control device 50.

Third step: determining presence or absence of the occurrence of an abnormality

The control device 50 determines the presence or absence of the occurrence of an abnormality based on the abnormal state presence/absence information included in the read reply communication message transmitted from the beamformer integrated circuit 10.

Fourth step: transmission of read instruction communication message for instructing to read out information indicating abnormal state

In a case where the control device 50 determines the occurrence of an abnormality, the control device 50 transmits, to the beamformer integrated circuit 10, a read instruction communication message (third communication message) for instructing to specify an address to read out information indicating an abnormal state stored in a register to which the address is assigned.

Fifth step: transmission of read reply communication message including read information and abnormal state presence/absence information

In a case where the beamformer integrated circuit 10 receives the read instruction communication message transmitted from the control device 50 in the fourth step, the beamformer integrated circuit 10 transmits a read reply communication message (second communication message) including the information (first information) indicating the abnormal state stored in the region specified by the address included in the read instruction communication message and the abnormal state presence/absence information (second information) to the control device 50.

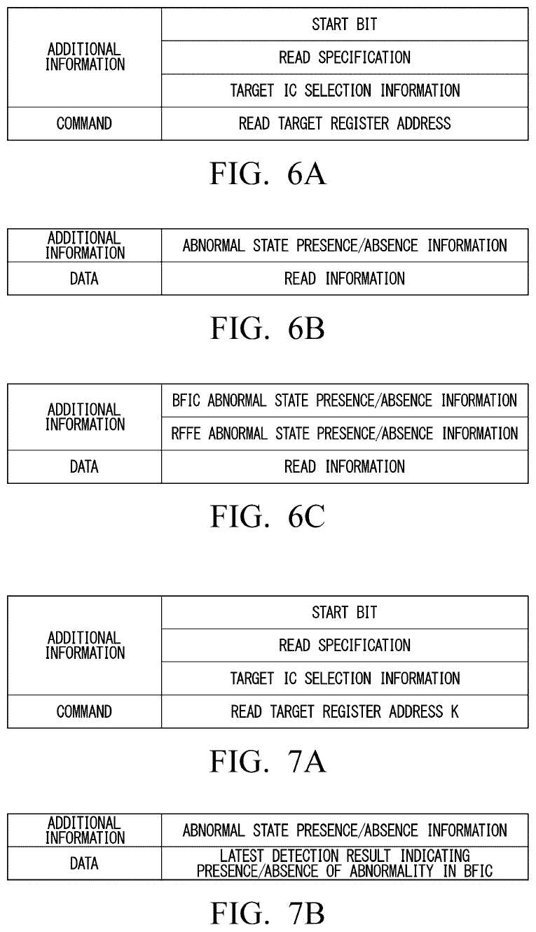

FIGS. 6A to 6C are diagrams showing examples of a read instruction communication message and a read reply communication message transmitted and received between the control device and the beamformer integrated circuit in the first embodiment of the present invention. FIG. 6A is a diagram showing a read instruction communication message transmitted from the control device 50 to the beamformer integrated circuit 10. FIGS. 6B and 6C are diagrams showing examples of read reply communication messages transmitted from the beamformer integrated circuit 10 to the control device 50.

As shown in FIG. 6A, the read instruction communication message transmitted from the control device 50 to the beamformer integrated circuit 10 includes additional information and a command. The additional information includes, for example, a start bit, information indicating read specification, and target IC selection information. The target IC selection information is IC address information for selecting and specifying the frequency conversion integrated circuit 30 or the beamformer integrated circuit 10 as a communication target of the control device 50 in the phased array antenna module 1. As a command of the read instruction communication message, the address of a register to be read out is specified.

As shown in FIGS. 6B and 6C, the read reply communication message transmitted from the beamformer integrated circuit 10 to the control device 50 includes additional information and data. The additional information includes only the abnormal state presence/absence information in the example shown in FIG. 6B, but includes the BFIC abnormal state presence/absence information and the RFFE abnormal state presence/absence information in the example shown in FIG. 6C. The abnormal state presence/absence information, the BFIC abnormal state presence/absence information, and the RFFE abnormal state presence/absence information included in the additional information are each information of 1 bit. These pieces of information mean that an abnormal state has occurred in a case where the value is “1”, and mean that an abnormal state has not occurred in a case where the value is “0”.

The data is read out from a register to which an address included in the read instruction communication message is assigned. In this way, in the present embodiment, the read reply communication message includes the abnormal state presence/absence information or the BFIC abnormal state presence/absence information and the RFFE abnormal state presence/absence information as the additional information, in addition to the data read out based on the read instruction communication message. Therefore, the control device 50 can detect the presence or absence of an abnormal state each time the read reply communication message is acquired.

The read reply communication message shown in FIG. 6B is transmitted, for example, in a case where the address specified in the read instruction communication message is an address of a register provided in the digital circuit 6 of the beamformer integrated circuit 10. The read reply communication message shown in FIG. 6C is transmitted, for example, in a case where the address specified by the read instruction communication message is an address of a register provided in the digital circuit unit 11 of the RF front end 5.

As described above, the abnormal state presence/absence information, which is the additional information of the read reply communication message shown in FIG. 6B, is set to a value of “1” in a case where the value of the information stored in the register to which the address K+1 shown in FIG. 5 is assigned is not “0”. In addition, similarly to the abnormal state presence/absence information, the BFIC abnormal state presence/absence information, which is the additional information of the read reply communication message shown in FIG. 6C, is set to a value of “1” in a case where the value of the information stored in the register to which the address K+1 shown in FIG. 5 is assigned is not “0”. In a case where the value of the information stored in the register to which the address L+1 shown in FIG. 5 is assigned is not “0”, the value of the RFFE abnormal state presence/absence information is set to “1”.

FIGS. 7A and 7B are diagrams showing an example of a communication message in a case where the information stored in the register to which the address K is assigned is read out in the first embodiment of the present invention. FIG. 7A is a diagram showing a read instruction communication message transmitted from the control device 50 to the beamformer integrated circuit 10. FIG. 7B is a diagram showing an example of a read reply communication message transmitted from the beamformer integrated circuit 10 to the control device 50. The read instruction communication message shown in FIG. 7A is transmitted in the fourth step described above, for example, in a case where the occurrence of an abnormality is determined in the third step described above. The read reply communication message shown in FIG. 7B is transmitted in, for example, the fifth step described above.

In a case where the information stored in the register to which the address K is assigned is read out, as shown in FIG. 7A, the address K of the register to be read out is specified as a command of the read instruction communication message. In addition, as shown in FIG. 7B, information (third information) indicating the latest detection result indicating the presence or absence of an abnormality in the beamformer integrated circuit 10 is stored as the data of the read reply communication message (see FIG. 5). In addition, even in a case where the information stored in the register to which the address K is assigned is read out, the read reply communication message includes abnormal state presence/absence information.

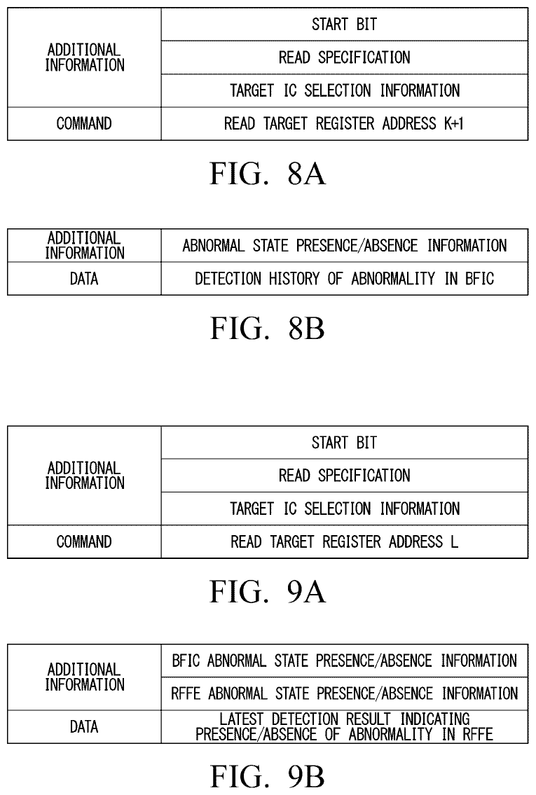

FIGS. 8A and 8B are diagrams showing an example of a communication message in a case where the information stored in the register to which the address K+1 is assigned is read out in the first embodiment of the present invention. FIG. 8A is a diagram showing a read instruction communication message transmitted from the control device 50 to the beamformer integrated circuit 10. FIG. 8B is a diagram showing an example of a read reply communication message transmitted from the beamformer integrated circuit 10 to the control device 50. The read instruction communication message shown in FIG. 8A is transmitted in the fourth step described above, for example, in a case where the occurrence of an abnormality is determined in the third step described above. The read reply communication message shown in FIG. 8B is transmitted in, for example, the fifth step described above.

In a case where the information stored in the register to which the address K+1 is assigned is read out, as shown in FIG. 8A, the address K+1 of the register to be read out is specified as a command of the read instruction communication message. In addition, as shown in FIG. 8B, information (fourth information) indicating the detection history of an abnormality in the beamformer integrated circuit 10 is stored as the data of the read reply communication message (see FIG. 5). In addition, even in a case where the information stored in the register to which the address K+1 is assigned is read out, the read reply communication message includes abnormal state presence/absence information.

FIGS. 9A and 9B are diagrams showing an example of a communication message in a case where the information stored in the register to which the address L is assigned is read out in the first embodiment of the present invention. FIG. 9A is a diagram showing a read instruction communication message transmitted from the control device 50 to the beamformer integrated circuit 10. FIG. 9B is a diagram showing an example of a read reply communication message transmitted from the beamformer integrated circuit 10 to the control device 50. The read instruction communication message shown in FIG. 9A is transmitted in the fourth step described above, for example, in a case where the occurrence of an abnormality is determined in the third step described above. The read reply communication message shown in FIG. 9B is transmitted in, for example, the fifth step described above.

In a case where the information stored in the register to which the address L is assigned is read out, as shown in FIG. 9A, the address L of the register to be read out is specified as a command of the read instruction communication message. In addition, as shown in FIG. 9B, information (third information) indicating the latest detection result indicating the presence or absence of an abnormality in the RF front end 5 is stored as the data of the read reply communication message (see FIG. 5). In addition, even in a case where the information stored in the register to which the address L is assigned is read out, the read reply communication message includes BFIC abnormal state presence/absence information and RFFE abnormal state presence/absence information.

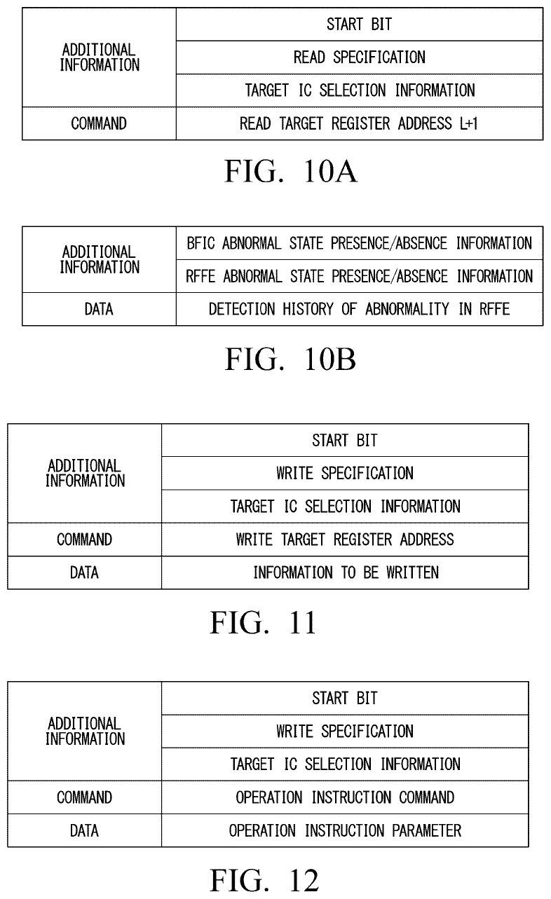

FIGS. 10A and 10B are diagrams showing an example of a communication message in a case where the information stored in the register to which the address L+1 is assigned is read out in the first embodiment of the present invention. FIG. 10A is a diagram showing a read instruction communication message transmitted from the control device 50 to the beamformer integrated circuit 10. FIG. 10B is a diagram showing an example of a read reply communication message transmitted from the beamformer integrated circuit 10 to the control device 50. The read instruction communication message shown in FIG. 10A is transmitted in the fourth step described above, for example, in a case where the occurrence of an abnormality is determined in the third step described above. The read reply communication message shown in FIG. 10B is transmitted in, for example, the fifth step described above.

In a case where the information stored in the register to which the address L+1 is assigned is read out, as shown in FIG. 10A, the address L+1 of the register to be read out is specified as a command of the read instruction communication message. In addition, as shown in FIG. 10B, information (fourth information) indicating the detection history of an abnormality in the RF front end 5 is stored as the data of the read reply communication message (see FIG. 5). In addition, even in a case where the information stored in the register to which the address L+1 is assigned is read out, the read reply communication message includes BFIC abnormal state presence/absence information and RFFE abnormal state presence/absence information.

FIG. 11 is a diagram showing an example of a write instruction communication message transmitted from the control device to the beamformer integrated circuit. The write instruction communication message (i.e., write request communication message) is a communication message for instructing to specify an address to write information into a register to which the address is assigned. As shown in FIG. 11, the write instruction communication message transmitted from the control device 50 to the beamformer integrated circuit 10 includes data in addition to additional information and a command. The additional information includes, for example, a start bit, information indicating write specification, and target IC selection information. As the command of the write instruction communication message, the address of a register to be written is specified. The data is information to be written into the register.

The control device 50 transmits the write instruction communication message shown in FIG. 11 to the beamformer integrated circuit 10 to write the specified data into the register to which the specified address is assigned. For example, an amplification factor setting value that defines the amplification factor of the power amplifier 65 is written into the register to which the address M is assigned, and an amplification factor setting value that defines the amplification factor of the low-noise amplifier 67 is written into the register to which the address M+1 is assigned.

In a case where the gain setting value that defines the gain of the power amplifier 65 is to be written, the control device 50 specifies the address M as a command and transmits a write instruction communication message in which the gain setting value to be written as data is specified, to the beamformer integrated circuit 10. In a case where the gain setting value that defines the gain of the low-noise amplifier 67 is to be written, the control device 50 specifies the address M+1 as a command and transmits a write instruction communication message in which the gain setting value to be written as data is specified, to the beamformer integrated circuit 10. In this way, by setting the values of the registers provided in the digital circuit unit 11 of the RF front end 5, each of the element components of the analog circuit unit 12 of the RF front end 5 is controlled.

FIG. 12 is a diagram showing an example of an operation instruction communication message transmitted from the control device to the beamformer integrated circuit. The operation instruction communication message (i.e., operation request communication message) is a communication message for instructing the execution of a specific operation. As shown in FIG. 12, the operation instruction communication message transmitted from the control device 50 to the beamformer integrated circuit 10 includes data in addition to additional information and a command, similarly to the write instruction communication message. The additional information includes, for example, a start bit, information indicating write specification, and target IC selection information, similarly to the write instruction communication message. As the command of the operation instruction communication message, an operation instruction command is specified. As the data, an operation instruction parameter is specified.

For example, in a case where an instruction to reflect information on an operation setting value, which is stored in a register provided in the digital circuit unit 11 of the RF front end 5, in the control of each element component provided in the analog circuit unit 12 of the RF front end 5 is to be performed, the control device 50 transmits an operation instruction command. Alternatively, the control device 50 transmits an operation instruction command in a case where an instruction related to the beam forming operation is issued.

As described above, the present embodiment includes abnormality detection circuits such as the abnormality detection circuit 16 that detects the abnormality of the output power of the power amplifier 65 and the protocol abnormality detection circuit that detects the communication protocol error. The information indicating the detection history of abnormalities detected by the abnormality detection circuits is stored in the register to which the address K+1 is assigned or the register to which the address L+1 is assigned. Then, in a case where the beamformer integrated circuit 10 receives the read instruction communication message transmitted from the control device 50, the beamformer integrated circuit 10 transmits a read reply communication message including the information stored in the region specified by the address included in the read instruction communication message and the abnormal state presence/absence information to the control device 50. As a result, the control device 50 can detect the presence or absence of an abnormal state each time the read reply communication message is acquired, and can detect the occurrence of the abnormal state at an early stage without requiring a dedicated wired communication circuit.

In addition, in the present embodiment, in a case where the control device 50 detects the occurrence of an abnormality from the abnormal state presence/absence information included in the read reply communication message, the control device 50 transmits the read instruction communication message shown in FIG. 7A or FIG. 9A. The control device 50 can receive the read reply communication message shown in FIG. 7B or FIG. 9B to obtain the information indicating the latest detection result indicating the presence or absence of an abnormality in the beamformer integrated circuit 10 and the information indicating the latest detection result indicating the presence or absence of an abnormality in the RF front end 5. As a result, the control device 50 can know whether or not the abnormal state is continuing.

Alternatively, in the present embodiment, in a case where the control device 50 detects the occurrence of an abnormality from the abnormal state presence/absence information included in the read reply communication message, the control device 50 transmits the read instruction communication message shown in FIG. 8A or FIG. 10A. The control device 50 can receive the read reply communication message shown in FIG. 8B or FIG. 10B to obtain information indicating the detection history of an abnormality in the beamformer integrated circuit 10 or information indicating the detection history of an abnormality in the RF front end 5. As a result, the control device 50 can know what an abnormality has occurred in the past.

Furthermore, in the present embodiment, the control device 50 can know whether, for the abnormality with the detection history, the abnormal state is still continuing or has been resolved by comparing the information obtained by the read reply communication message shown in FIG. 7B or FIG. 9B with the information obtained by the read reply communication message shown in FIG. 8B or FIG. 10B.

In this way, in the present embodiment, even in an analog integrated circuit that does not include a processor or the like such as the beamformer integrated circuit 10 and that includes only a simple logic circuit, it is possible to detect the occurrence of an abnormal state at an early stage.

### Second Embodiment

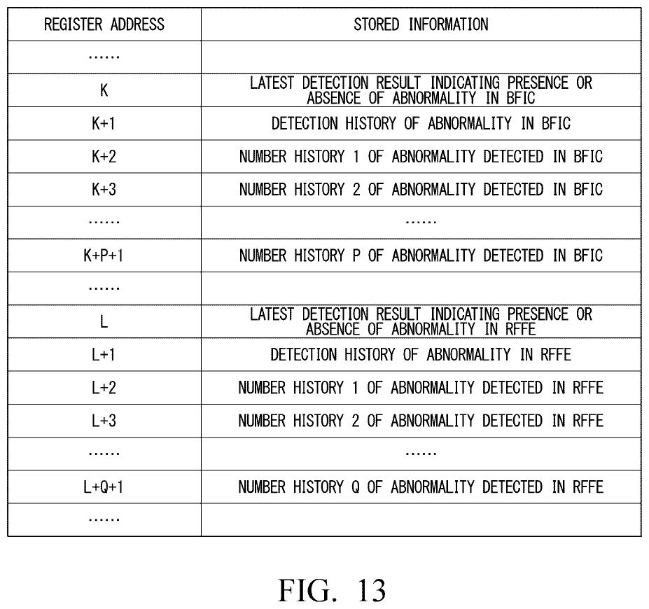

FIG. 13 is a diagram showing an example of a memory map of registers provided in a beamformer integrated circuit according to a second embodiment of the present invention. The present embodiment is different from the first embodiment only in the configuration of the memory map, and the configuration of the wireless communication device DV including the beamformer integrated circuit 10 is substantially the same as that of the first embodiment. Therefore, hereinafter, matters related to the memory map of the registers will be mainly described in detail.

### <Memory Map of Register>

The beamformer integrated circuit 10 of the present embodiment is different from the first embodiment in that a plurality of histories of information (abnormal state numbers) indicating a state of the abnormality detected by the abnormality detection circuit provided in the digital circuit 6 of the beamformer integrated circuit 10 can be stored in the registers provided in the digital circuit 6. In addition, the beamformer integrated circuit 10 of the present embodiment is different from the first embodiment in that a plurality of histories of information (abnormal state numbers) indicating the state of the abnormality detected by the abnormality detection circuit provided in the digital circuit unit 11 of the RF front end 5 can be stored in the registers provided in the digital circuit unit 11 of the RF front end 5.

The abnormal state numbers are numbers indicating the details of an abnormality assigned for each abnormal state. For example, for the communication protocol error, in a case where the additional information is read specification but broadcast is specified in the target IC selection information, the abnormal state number 51 is assigned. In addition, in a case where the additional information is write specification and the target IC selection information is target IC selection information of a single beamformer integrated circuit 10 but the register address to be written is a write target register address of the frequency conversion integrated circuit 30, or in a case where the target IC selection information is target IC selection information of the frequency conversion integrated circuit 30 but the register address to be written is a write target register address of the beamformer integrated circuit 10, the abnormal state number 52 is assigned.

In the first embodiment, a value indicating the presence or absence of an abnormality is set in a specific one bit (one bit corresponding to the detected abnormality) of the register to which the address K is assigned and the register to which the address K+1 is assigned. The same applies to the register to which the address L is assigned and the register to which the address L+1 is assigned. Therefore, in the first embodiment, it is possible to know the presence or absence of an abnormality, but it is not possible to know the details of an abnormal state. In the present embodiment, the history of an abnormal state number is stored, so that the details of an abnormal state can be known.

Specifically, as shown in FIG. 13, P histories (fifth information) of abnormal state numbers related to abnormalities detected by the beamformer integrated circuit 10 can be stored in P registers (third storage region) to which the address K+2 to an address K+P+1, which are provided in the digital circuit 6 are assigned. In addition, Q histories (fifth information) of abnormal state numbers related to abnormalities detected by the RF front end 5 can be stored in Q registers (third storage region) to which the address L+2 to an address L+Q+1, which are provided in the digital circuit unit 11 of the RF front end 5, are assigned. P and Q may be the same numerical value or different numerical values.

In the present embodiment, in a case where an abnormality is detected in the beamformer integrated circuit 10, similarly to the first embodiment, the value of a specific bit (bit corresponding to the detected abnormality) of the register to which the address K is assigned and the register to which the address K+1 is assigned is set to, for example, “1”. In addition, in the present embodiment, abnormal state numbers are stored in any of the registers to which the address K+2 to the address K+P+1 are assigned.

For example, how many of the P registers to which the address K+2 to the address K+P+1 are assigned store abnormal state numbers is managed using a counter (not shown) provided in the digital circuit 6. Then, a new abnormal state number is stored in a register to which an address next to an address indicated by the counter is assigned. In a case where an abnormal state number is stored up to a register to which the address K+P+1 is assigned, the counter is reset such that the next abnormal state number is stored in the register to which the address K+2 is assigned.

Here, only P abnormal state numbers can be stored. Therefore, in a case where an abnormal state number to be stored this time is the same as an abnormal state number stored last time, the digital circuit 6 of the beamformer integrated circuit 10 may omit storing information on an abnormal state numbers.

In addition, in the present embodiment, in a case where an abnormality is detected in the RF front end 5, similarly to the first embodiment, values of specific bits (bits corresponding to the detected abnormalities) of the register to which the address L is assigned and the register to which the address L+1 is assigned are set to, for example, “1”. In addition, in the present embodiment, abnormal state numbers are stored in any of the registers to which the address L+2 to the address L+Q+1 are assigned.

For example, how many of the Q registers to which the address L+2 to the address L+Q+1 are assigned store abnormal state numbers is managed using a counter (not shown) provided in the digital circuit unit 11 of the RF front end 5. Then, a new abnormal state number is stored in a register to which an address next to an address indicated by the counter is assigned. In a case where an abnormal state number is stored up to a register to which the address L+Q+1 is assigned, the counter is reset such that the next abnormal state number is stored in the register to which the address L+2 is assigned.

Here, only Q abnormal state numbers can be stored. Therefore, in a case where an abnormal state number to be stored this time is the same as an abnormal state number stored last time, the digital circuit unit 11 of the RF front end 5 may omit storing information on an abnormal state number.

In a case where a read instruction communication message (first communication message) which specifies an address of a register (third storage region) in which an abnormal state number is stored is received, the beamformer integrated circuit 10 transmits a read reply communication message including the abnormal state number (fifth information) stored in the register specified by the address included in the read instruction communication message and the abnormal state presence/absence information.

### <Abnormal State Acquisition Method>

The method of acquiring the history of the abnormal state numbers stored in the P registers to which the address K+2 to the address K+P+1 are assigned is basically the same as the abnormal state acquisition method described in the first embodiment. In addition, the method of acquiring the history of the abnormal state numbers stored in the Q registers to which the address L+2 to the address L+Q+1 are assigned is basically the same as the abnormal state acquisition method described in the first embodiment.

That is, in a case where the occurrence of an abnormality is determined in the third step described above, the control device 50 transmits a read instruction communication message in which one of the addresses of the registers in which the abnormal state numbers are stored in the fourth step described above is specified. Then, in the fifth step described above, the read reply communication message in which the abnormal state number is stored is transmitted from the beamformer integrated circuit 10 to the control device 50. In this way, the control device 50 can acquire the abnormal state number stored in the beamformer integrated circuit 10.

Here, the control device 50 repeats the fourth step described above while sequentially changing addresses to be specified, and sequentially transmits the read instruction communication messages to the beamformer integrated circuit 10. As a result, the control device 50 can sequentially acquire the abnormal state numbers stored in the beamformer integrated circuit 10.

Specifically, the control device 50 manages how many of the P registers to which the address K+2 to the address K+P+1 are assigned have acquired abnormal state numbers, and performs reading of a register of the next address. Then, when an abnormal state number has been acquired up to the register to which the address K+P+1 is assigned, an address to be instructed next is set to the address K+2.

Similarly, the control device 50 manages how many of the Q registers to which the address L+2 to the address L+Q+1 are assigned have acquired abnormal state numbers, and performs reading of a register of the next address. Then, when an abnormal state number is acquired up to the register to which the address L+Q+1 is assigned, an address to be instructed next is set to the address L+2.

Information indicating how many of the P registers to which the address K+2 to the address K+P+1 are assigned store abnormal state numbers is stored, for example, in a register (not shown) provided in the digital circuit 6. Similarly, information indicating how many of the Q registers to which the address L+2 to the address L+Q+1 are assigned store abnormal state numbers is stored in a register (not shown) provided in the digital circuit unit 11 of the RF front end 5. The control device 50 acquires the information stored in the registers and acquires the above-described abnormal state numbers up to a register to which an address specified by the acquired information is assigned.

In this way, the control device 50 can more specifically detect the contents of the generated abnormal states that have occurred. In addition, by sequentially acquiring a plurality of abnormal state numbers, it is possible to acquire the details of the generated abnormal states that have occurred in time series.

As described above, the wireless communication device of the present embodiment basically has the same configuration as the wireless communication device DV of the first embodiment. Therefore, in the present embodiment as well, similarly to the first embodiment, it is possible to detect the occurrence of an abnormal state at an early stage without requiring a dedicated wired communication circuit, it is possible to know whether or not the abnormal state is continuing, and it is possible to know what kind of abnormality has occurred in the past.

In addition, in the present embodiment, the history of the information (abnormal state numbers) (fifth information) indicating the state of the abnormality detected by the beamformer integrated circuit 10 is stored in the P registers (third region) to which the address K+2 to the address K+P+1 are assigned or the Q registers (third region) to which the address L+2 to the address L+Q+1 are assigned. Then, in a case where a read instruction communication message for instructing reading of the information stored in the registers is received, the beamformer integrated circuit 10 transmits a read reply communication message (second communication message) including the abnormal state numbers stored in these registers. As a result, it is possible to detect the contents of the generated abnormal states that have occurred in more detail.

Although the integrated circuit and the abnormality history management method according to the embodiments of the present invention have been described above, the present invention is not limited to the above-described embodiments and can be freely modified within the scope of the present invention. The phased array antenna module described in the above embodiments is for the time division multiplexing system. However, the phased array antenna module of the present invention may be for a frequency division multiplexing system.

In addition, in the above-described embodiments, an example has been described in which the one antenna element 21 is connected to the one RF front end 5 on a one-to-one basis. However, in the present invention, two front ends may be connected to a dual polarization antenna element having a connection terminal for horizontal polarization and a connection terminal for vertical polarization.

In addition, it is possible to appropriately replace the constituent elements in the above-described embodiment with well-known constituent elements and the above-described embodiments and modification examples may be appropriately combined without departing from the scope of the present invention.

What is claimed is:

1. An integrated circuit comprising:
an abnormality detection circuit configured to detect presence or absence of an abnormality; and
a storage region including a detection result storage region configured to store a detection result of the abnormality detection circuit,
wherein, in a case where a first communication message for instructing to specify an address to read out information stored in the storage region is received, a second communication message including first information stored in a region of the storage region, which is specified by the address, and second information indicating presence or absence of occurrence of an abnormality based on the detection result stored in the detection result storage region is transmitted.

2. The integrated circuit according to claim 1,
wherein the detection result storage region includes
a first storage region configured to store third information indicating a latest detection result of the abnormality detection circuit, and
a second storage region provided to correspond to the first storage region and configured to store fourth information indicating a detection history of the abnormality detected by the abnormality detection circuit, and
in a case where the fourth information is stored in the second storage region, the second communication message including the second information indicating the occurrence of the abnormality is transmitted.

3. The integrated circuit according to claim 2,
wherein, in a case where the first communication message for instructing to specify the address of the first storage region to read out the information stored in the first storage region is received, the second communication message including the third information stored in the first storage region as the first information is transmitted.

4. The integrated circuit according to claim 1,
wherein the detection result storage region includes a third storage region configured to store fifth information indicating a state of the abnormality detected by the abnormality detection circuit as a plurality of histories, and
in a case where the first communication message for instructing to specify an address of the third storage region to read out the information stored in the third storage region is received, the second communication message including the fifth information stored in a region of the third storage region as the first information, which is specified by the address, is transmitted.

5. A wireless communication device comprising:
the integrated circuit according to claim 1; and
a control device configured to transmit the first communication message to the integrated circuit,
wherein the control device determines presence or absence of occurrence of an abnormality based on the second information included in the second communication message transmitted from the integrated circuit.

6. The wireless communication device according to claim 5,
wherein the control device transmits, in a case where the occurrence of the abnormality is determined, a third communication message for instructing to specify an address to read out the information stored in the detection result storage region to the integrated circuit.

7. An abnormal state acquisition method comprising:
a first step of transmitting the first communication message to the integrated circuit according to claim 1 via a control device; and
a second step of transmitting the second communication message to the control device in a case where the integrated circuit receives the first communication message.

8. The abnormal state acquisition method according to claim 7, further comprising:
a third step of determining presence or absence of occurrence of an abnormality based on the second information included in the second communication message transmitted from the integrated circuit, via the control device; and
a fourth step of transmitting, in a case where the control device determines the occurrence of the abnormality, a third communication message for instructing to specify an address to read out the information stored in the detection result storage region, to the integrated circuit.
